(19) United States
(12) Patent Application Publication
(10) Pub. No.: US 2003/0006342 A1
(43) Pub. Date: Jan. 9, 2003

(54) Aircraft with safety area for pilots

(76) Inventor: John Splawn Page JR., Lake Forest, CA (US)

Correspondence Address: JOHN S. PAGE JR., 25092 FARTHING ST #61, LAKE FOREST, CA, 92630, US

(21) Appl. No.: 10/206,500

(22) Filed: Jul. 24, 2002

Related U.S. Application Data
(63) Continuation-in-part of application No. 09/752,705, filed on Dec. 28, 2000, now Pat. No. 6,452,482.
(63) Continuation-in-part of application No. 09/972,705, filed on Oct. 2, 2001.

(51) Int. Cl. B64D 13/00

(52) U.S. Cl. 244/118.5; 244/118.6

(57) ABSTRACT

An aircraft with an area of the fuselage that is isolated from the main passenger seating area by a lockable door in cooperation with adjacent walls and which said area includes the area and space about the pilots cockpit cabin entrance area, and or a restroom entrance area and or a galley entrance area creating an isolated area of the fuselage floor plan for the security, privacy and safety of the crew members.

### BACKGROUND OF BOTH OF THESE INVENTIONS

The terrorist high-jacking of 4 commercial aircraft and using them as bombs to attack America's Trade Buildings and the Pentagon and possibly the White House on Sep. 11, 2001 demonstrated the vulnerability of America's commercial aircraft to being high-jacked and used as giant flying bombs.

### SUMMERY OF INVENTION

Applicant's invention provides an effective method of preventing terrorists from attempting a high jacking by building into an aircraft an area of the fuselage that is isolated and locked up securely from the main passenger seating area.

A special door is located away from the cockpit door to create an isolated area relative to the cockpit door. It can provide an isolated area that includes the pilots cockpit door, the restroom door and the galley entrance. When this door is locked, a pilot can exit his cabin and enter the restroom or the galley and the passengers on the other side of the door will not be able to see him. Therefore, he will not be vulnerable to a terrorist jumping him when he opens his cockpit door to go to the rest room. These doors can be made of Kevlar to make a very tough door that would be impossible to break through with ones bare hands or a knife and even bulletproof if the Kevlar is layered up with enough layers.

When this SECURITY SYSTEM becomes public knowledge, the terrorist will want to find easier ways to attack us. The flying public will be greatly reassured that the pilots are fully protected and that it is safe to fly again.

### DESCRIPTION OF DRAWINGS

FIG. 1 is a complete assembly of a framed door that is ready to be installed into existing aircraft. Some doors can operate up and down and some can traverse horizontally back and forth. FIG. 1 consists of a frame 24 and a header 3. The door 7 is of tough flexible bullet resistant material like KEVLAR.

The door 7 material is attached to the header 3 or to glides 26 in FIG. 5 depending on whether it traverses horizontally or vertically. If the door traverses vertically then the glides 26 are attached to the sides of the door material and the glides slide in the frame 24 vertically and the door material is fixed to and suspended from the header. If it traverses horizontally then the glides slide horizontally in the header 3.

FIG. 5 shows that the frame 24 extends past and beyond the connecting point where the door material 7 is attached to the glides 26 in the frame 24 and along with the shield 32, they block any access to the connection point of the door material to the glides. This prevents a terrorist from getting to that connecting point with any kind of tool in an attempt to break through the door. The shield 32 also acts as a retainer and guide for the glides.

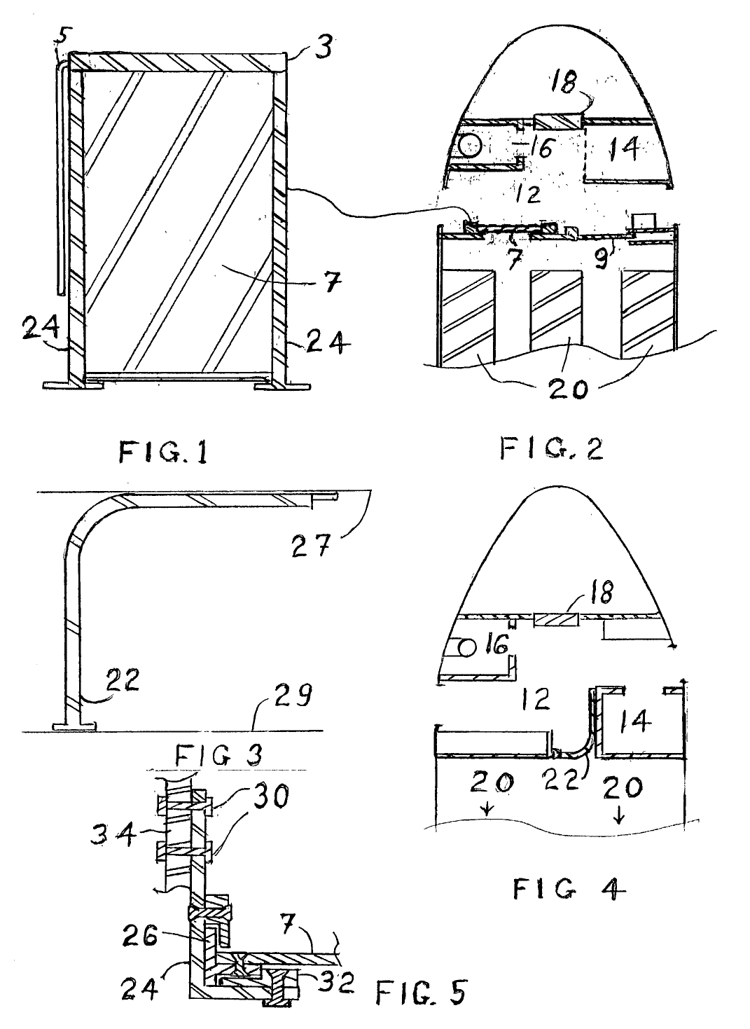

If the door is a vertically operating door then the pull cords 5 in FIG. 1 operate like those in many homes to raise and lower the door material 7.

FIG. 2 is a partial floor plan showing the door 7 and frame 24 installed at a passageway. A sliding type door 9 working out of a pocket in a wall is also shown at one of the passageways. When these doors are closed and locked, an ISOLATED AREA 12 is created.

FIG. 2 shows that the Galley 14, Rest Room 16 and Cockpit Door 18 are all isolated from the passenger seating area 20 for the safety of the crew.

FIG. 3 shows another type of isolating door that will roll up and back along tracks and is retained along and close to the ceiling 27 in its retracted position. This is a garage door type door and it can be motor driven with a screw drive principle like the GENIE Corporation manufactures for garages. It rolls down to the floor 29 where it can be locked.

FIG. 4 is partial floor plan that shows another type of door that is a hanging door 22. It traverses horizontally around a bend so that it can be lie back out of the way along a wall and then be drawn out around a bend in the overhead track and across the passage way to the frame 24 and locked.

FIG. 5 is a cross section in a plan view of the connecting means that connects the flexible door material 7 to the glides 26 that operate in the frame 24. The glides 26 slide up and down in the frame. If the type of door selected is one that traverses horizontally, then the glides traverse horizontally.

The frame assembly is bolted and riveted together in FIG. 5. It could also be welded together into a complete assembly. The frame 24 is bolted onto a wall 34 or structure as shown by bolts 30.

### DETAILED DESCRIPTION

This CONTINUEATION IN PART utilizes the cockpit door that is in existing planes as one of the two doors in applicants scheme and it uses another door located back away from the cockpit door some feet in cooperation with adjacent walls to create an isolated area away from the cockpit door. This door is an additional door that is not in existing aircraft and it is necessary to create an isolated area that is secure. The novel two-door feature of applicant's invention makes such an isolated area possible. Several types of doors can be used to accomplish this novel result of an isolated space.

One type of Isolating Door is a flexible sliding door like a shower curtain that slides back away from the frame at one side of the passageway where it was latched and locked. The door material is attached to glides or rollers that operate in an overhead track. The glides or rollers suspend the door material from the track.

This door would be opened by retracting it either straight back or around a bend in the track to where it may lie along a wall.

Another form of door is one that is operated up and down like venetian blinds with pull cords or it may be motorized. These doors can be made of Kevlar with multiple layers to achieve a tough enough door so that it can not be kicked in by anyone. It can also be layered up to be bulletproof like the military uses to protect munitions. They are called Munitions Blankets.

One form of door that is shown in FIG. 1 of the drawings is one that has a frame with right and left vertical posts and with a header across the top. This makes it a complete unit that is pre-assembled so it can be carried into most existing aircraft and bolted into place across a passageway.

Another type of isolating door is one that would roll up and back along tracks and is retained along and close to the ceiling. This is a garage door type door and it can be motor driven with a screw drive principle like the GENIE Corporation manufactures for garages. It rolls down to the floor where it is locked.

The object of these forms of prefab doors is to have units that can to be installed into existing aircraft with almost no modification to the plane. Depending what model and make of aircraft, one of these isolating doors can be customized and be adapted to isolate the area of the galley and or restroom and the pilot's cockpit door.

Even a conventional swinging door that is lockable could be used to create the isolated area if there are walls or structures that would accommodate it.

Another form of this invention is for newly designed aircraft where the feature of an Isolating Door is incorporated into the original design of an aircraft.

An ideal type of door for new aircraft is a sliding door that operates in and out of pocket or space in a wall that separates the passengers from the desired isolating area.

It could also be a sliding door that retracts along the outside of a wall and is retained there in an open position with appropriate framing or tracking means and then slides across the passageway to block it.

1. An aircraft having:
a) flight control cabin with seating for one or more pilots,
b) a doorway for entering and exiting said cabin and said doorway having a cockpit door to block the cabin doorway,
c) one or more secondary doors cooperating with walls or structures that are set off away from said cockpit door so that there is an isolated space between the cockpit door and said secondary door, thereby blocking access from the passenger section of the aircraft into the isolated space.

2. The claim of claim one whereby said secondary door is located to where it isolates the cockpit door and the restroom entrance area.

3. The claim of claim one whereby said secondary door is located to where it isolates a galley entrance area.

4. The claim of claim one whereby said secondary door is located to where it would isolate a restroom entrance area, a galley entrance area as well as the pilots cockpit door in one secure isolated area of the fuselage floor plan.

5. The claim of claim one whereby said door is a roll up type door so that when it is retracted it is retained along and parallel to the ceiling.

6. The claim of claim one whereby said secondary door or doors are lockable doors.

7. The claim of claim one whereby said door is made of bullet resistant or bulletproof material.

8. The claim of claim one whereby said door operates horizontally and the moving, opening and closing part of said door is made of a flexible material.

9. The claim of claim one whereby said door operates up and down and the moving opening and closing part of said door is made of a flexible material.

10. The claim of claim one whereby said door operates horizontally and the moving, opening and closing part of said door is made of a ridged material.

11. The claim of claim one whereby said door is a sliding door that operates horizontally moving in and out of a pocket in a wall.

12. The claim of claim one whereby said door retracts horizontally to open a passageway and is retained along of a wall.

13. The claim of claim one whereby said door swings on hinges.

14. The claim of claim 5 whereby said roll up type door is operated by a motor.

15. The claim of claim one whereby the material of said door is connected to glides that traverse up and down or traverse horizontally in a frame.

16. The claim of claim one that includes a frame and said frame extends past and beyond the connecting point where the door material is attached to the glides in the frame thereby creating a shield to block any access to the connection point of the door material to the glides.
